(19) United States
(12) Patent Application Publication
(10) Pub. No.: US 2003/0118204 A1
(43) Pub. Date: Jun. 26, 2003

(54) Wireless microphone

(76) Inventors: Yuji Kawasaki, Sagamihara-shi (JP); Sadahiro Gomi, Yokohama-shi (JP); Hideaki Ishikawa, Yokohama-shi (JP)

Correspondence Address: PEARNE & GORDON LLP, 526 SUPERIOR AVENUE EAST, SUITE 1200, CLEVELAND, OH, 44114-1484, US

(21) Appl. No.: 10/296,188

(22) PCT Filed: Apr. 9, 2002
(86) PCT No.: PCT/JP02/03547

(30) Foreign Application Priority Data
Apr. 10, 2001 (JP) 2001-111646

(51) Int. Cl. H04B 3/00; H04R 9/08; H04R 11/04; H04R 17/02; H04R 19/04; H04R 21/02

(52) U.S. Cl. 381/355; 381/77; 381/361

(57) ABSTRACT

An object of the present invention is to provide a miniaturized wireless microphone.

The wireless microphone according to the invention is characterized by including a microphone unit 11 and a helical antenna 23 for irradiating a high frequency signal based on an audio signal outputted from the microphone unit 11, wherein the helical antenna 23 is disposed in adjacent to the rear surface side of the microphone unit 11.

### TECHNICAL FIELD

The present invention relates to a wireless microphone and, in particular, relates to a unidirectional wireless microphone.

### BACKGROUND OF THE INVENTION

Conventionally, there have been known unidirectional wireless microphones each having a unidirectional microphone unit and a helical antenna for radiating a high frequency signal. In such a unidirectional wireless microphone, it is necessary to provide a space and a sound port on the rear surface side of the microphone unit in order to obtain predetermined unidirectivity. Further, the helical antenna is required to be provided at a space avoiding a metal portion etc. having a large area or protrusively provided from a main body.

However, according to the conventional unidirectional wireless microphone, since a dedicated space is required for each of the microphone unit and the helical antenna, there arises a problem that the size of the unidirectional wireless microphone becomes large.

Accordingly, the present invention has been made in view of the aforesaid problem of the conventional technique and an object of the present invention is to provide a miniaturized wireless microphone.

### DISCLOSURE OF THE INVENTION

In order to attain the aforesaid object, firstly, the wireless microphone according to the invention includes a microphone unit and a helical antenna for irradiating a high frequency signal based on an audio signal outputted from the microphone unit, wherein the helical antenna is disposed in adjacent to a rear surface side of the microphone unit. Thus, such a wireless microphone has a function of making it possible to miniaturize the microphone.

Secondly, the wireless microphone according to the invention further includes a housing portion provided on the rear surface side of the microphone unit and containing a space therein, wherein the helical antenna is provided within the space of the housing portion. Thus, such a wireless microphone has a function of making it possible to miniaturize the microphone.

Thirdly, the wireless microphone according to the invention further includes a clip attachment portion coupled to the housing portion and a clip portion having a leaf spring attached to the clip attachment portion. Thus, such a wireless microphone has a function of making it possible to be attached easily to a breast pocket of a shirt or a suit etc.

Fourthly, the wireless microphone according to the invention further includes a conductive line for transmitting the audio signal outputted from the microphone unit to a main board, wherein the conductive line is passed within a space surrounded by the helical antenna so as to be movable with respect to the helical antenna. Thus, such a wireless microphone has a function of making it possible to improve the irradiation efficiency.

Fifthly, the wireless microphone according to the invention further includes a disc shaped antenna board for supporting the helical antenna and a chassis having a convex portion, wherein the convex portion supports the antenna board. Thus, such a wireless microphone has a function of making it possible to surely support the antenna board by the convex portion of the chassis.

Sixthly, the wireless microphone according to the invention is characterized in that a slit for holding the conductive line is provided at the antenna board. Thus, such a wireless microphone has a function of making it possible to surely hold the conductive line by the slit of the antenna board.

Seventhly, the wireless microphone according to the invention further includes the main board and a main body casing portion having the main board therein, wherein the main board is provided in an axial direction of the main body casing portion. Thus, such a wireless microphone has a function of making it possible to utilize the space within the main body casing portion effectively.

Eighthly, the wireless microphone according to the invention is characterized in that the wireless microphone is configured in a fountain pen shape entirely. Thus, such a wireless microphone has a function of making it possible to be attached easily to a breast pocket of a shirt or a suit etc.

### BRIEF DESCRIPTION OF THE DRAWINGS

FIG. 1 is a front view showing the main portion of a wireless microphone according to the embodiment of the invention.

FIG. 2 is a longitudinal sectional view showing the main portion of the wireless microphone according to the embodiment of the invention.

FIG. 3 is a diagram showing a state where the helical antenna and the peripheral portion thereof in the wireless microphone according to the embodiment are seen from the direction shown by an arrow A in FIG. 2.

FIG. 4 is a perspective view showing the helical antenna and the peripheral portion thereof.

In the drawings, a reference numeral 11 depicts a microphone unit, 14 a lead wire, 20 a space portion, 21 a space, 22 sound ports, 23 a helical antenna, 24 an antenna board and 27 a slit.

### BEST MODE FOR CARRYING OUT THE INVENTION

An embodiment according to the present invention will be explained with reference to accompanying drawings.

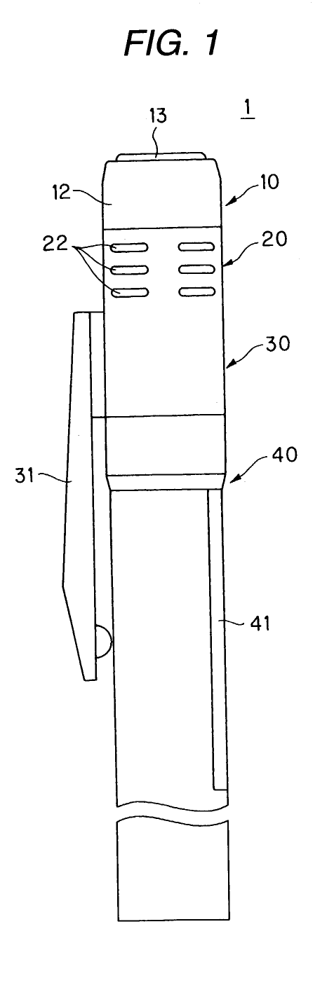

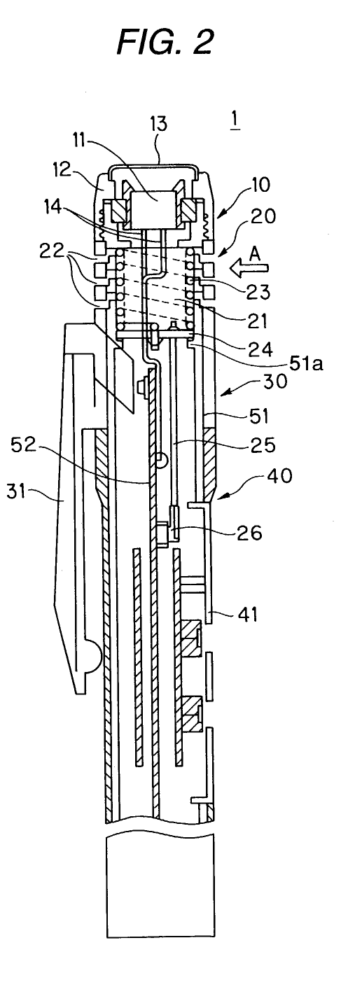

FIG. 1 is a front view showing the main portion of a wireless microphone according to the embodiment of the invention. FIG. 2 is a longitudinal sectional view showing the main portion of the wireless microphone according to the embodiment of the invention. In FIGS. 1 and 2, an almost cylindrical-shaped main body 1 of the wireless microphone according to the embodiment is provided with a microphone portion 10 formed by metal material, a space portion 20 formed by resin material which is non-metallic material not having shielding function and provided as a housing portion beneath the microphone portion 10 (the rear surface side of a microphone unit 11 described later), a clip attachment portion 30 formed by resin material integrally with the space portion 20 and provided beneath the space portion 20, and a main body casing portion 40 formed by metal material and provided beneath the clip attachment portion 30. The wireless microphone is configured in a fountain pen shape entirely.

The microphone portion 10 is provided with the unidirectional microphone unit (for example, an electret capacitor microphone) 11 formed by metal material etc. Further, a cap 12 formed by metal material is provided so as to cover the microphone unit 11. Furthermore, a protection net 13 formed by metal material is provided integrally with the cap 12 on the front surface side of the microphone unit 11. Although, the microphone portion 10 and the cap 12 are formed by metal material, they may be formed by resin material.

Within the space portion 20 serving as the housing portion on the rear surfaced side of the microphone unit 11, a space 21 for the microphone unit 11 is contained and a predetermined number of sound ports 22 communicating with the space 21 are provided. These space 21 and the sound ports 22 are provided in order to obtain the predetermined unidirectivity. A helical antenna 23 for irradiating a high frequency signal based on an audio signal outputted from the microphone unit 11 is provided within the space 21. Further, an almost disc-shaped antenna board 24 for supporting the helical antenna 23 is provided within the space.

A clip portion 31 having a leaf spring formed by metal material is attached to the clip attachment portion 30 so as to protrude from the main body 1. The wireless microphone according to the embodiment can be attached easily to a breast pocket of a shirt or a suit etc. due to the provision of the clip portion 31. Further, an operation panel 41 formed by resin material is provided at the main body casing portion 40.

A chassis 51 having a convex portion 51a used for supporting the antenna board 24 etc. and formed by resin material is provided from a part of the space portion 20 to the main body casing portion 40 along the inner peripheral surfaces thereof. A main board 52 constituting an electric circuit is provided within the space portion from a part of the clip attachment portion 30 to the main body casing portion 40 along the axial direction of the main body casing portion 40.

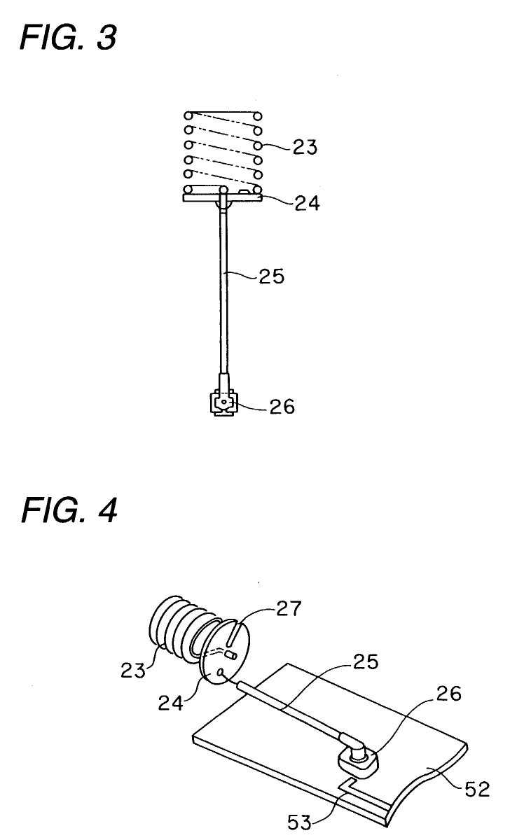

On the other hand, the helical antenna 23 provided within the space 21 of the space portion 20 is configured in a coil shape which is formed by winding a wire formed by stainless steel or phosphor bronze for spring by a predetermined number of times (5.5 times in this embodiment) as shown in FIG. 3 (a diagram seen from the direction shown by an arrow A in FIG. 2) and FIG. 4 (a perspective view). The helical antenna is supported by the antenna board (for example, a glass epoxy board) 24 as described above. The one end of the wire rod constituting the helical antenna 23 is coupled to a main board 52 through an antenna cable 25 and a connector 26. The microphone unit 11 is also coupled to the main board 52 through conductive lines, that is, lead wires 14. The lead wires 14 serve to transmit the audio signal outputted from the microphone unit 11 and are passed within the space surrounded by the helical antenna 23 so as to be movable with respect to the helical antenna 23. Further, as shown in FIG. 4, the antenna board 24 is provided with a slit 27 for holding the lead wires 14 (not shown in this figure) passed within the space. The main board 52 is provided with a ground pattern 53 for the helical antenna 23.

According to the wireless microphone of the embodiment having such a configuration, since the helical antenna 23 is provided within the space 21 (a shared space) for the microphone unit 11, the wireless microphone can be miniaturized. Further, since the helical antenna 23 is provided within the space 21 for the microphone unit 11, the helical antenna 23 can be disposed in adjacent to the microphone unit 11. Thus, the helical antenna 23 is high-frequency coupled with the microphone unit 11 and the lead wires 14, so that the irradiation efficiency of the helical antenna can be improved. To be more concrete, the irradiation efficiency can be adjusted by adjusting the relative position of the lead wires 14 passed within the space surrounded by the helical antenna 23 with respect to the helical antenna 23, and so the maximum irradiation efficiency can be obtained.

Although the present invention was explained with reference to the particular embodiment, it would be obvious for those skilled in the art that the invention may be modified or changed in various ways without departing from the spirit and scope of the invention.

The present application is based on Japanese Patent Application No. 111646/2001 filed on Apr. 10, 2001 and the contents thereof is incorporated herein by reference.

### INDUSTRIAL APPLICABILITY

As clear from the aforesaid explanation, according to the invention, since the helical antenna is provided within the space for the microphone unit, the miniaturized wireless microphone can be provided.

1. A wireless microphone comprising:
a microphone unit; and
a helical antenna for irradiating a high frequency signal based on an audio signal outputted from the microphone unit,
wherein the helical antenna is disposed in adjacent to a rear surface side of the microphone unit.

2. A wireless microphone according to claim 1, further comprising a housing portion provided on the rear surface side of the microphone unit and containing a space therein, wherein the helical antenna is provided within the space of the housing portion.

3. A wireless microphone according to claim 2, further comprising a clip attachment portion coupled to the housing portion and a clip portion having a leaf spring attached to the clip attachment portion.

4. A wireless microphone according to one of claims 1 to 3, further comprising a conductive line for transmitting the audio signal outputted from the microphone unit to a main board, wherein the conductive line is passed within a space surrounded by the helical antenna so as to be movable with respect to the helical antenna.

5. A wireless microphone according to one of claims 1 to 4, further comprising a disc shaped antenna board for supporting the helical antenna and a chassis having a convex portion, wherein the convex portion supports the antenna board.

6. A wireless microphone according to claims 5, wherein a slit for holding the conductive line is provided at the antenna board.

7. A wireless microphone according to claims 4, further comprising the main board and a main body casing portion having the main board therein, wherein the main board is provided in an axial direction of the main body casing portion.

8. A wireless microphone according to one of claims 1 to 7, the wireless microphone is configured in a fountain pen shape entirely.
